(19) United States
(12) Patent Application Publication
(10) Pub. No.: US 2002/0160266 A1
(43) Pub. Date: Oct. 31, 2002

(54) Graphite material for negative electrode of lithium ion secondary battery and process for producing the same

(75) Inventors: Yoshinori Yamazaki, Kashima-gun (JP); Toshifumi Kawamura, Kashima-gun (JP); Tetsuo Yamamoto, Kashima-gun (JP); Toshio Tamaki, Kashima-gun (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: PETOCA MATERIALS, LTD., Tokyo (JP)

(21) Appl. No.: 10/084,147

(22) Filed: Feb. 28, 2002

(30) Foreign Application Priority Data
Feb. 28, 2001 (JP) 2001-54494
Jun. 7, 2001 (JP) 2001-172813

(51) Int. Cl. H01M 4/58; C01B 31/04

(52) U.S. Cl. 429/231.8; 423/448

(57) ABSTRACT

According to the present invention, milled carbon fiber is mixed with a boron compound and graphitized in the presence of nitrogen, and thereafter subjected to modifying treatment by applying impact selectively to fiber edge parts of the carbon fiber.

The present invention can provide a graphite material produced in such a way that the milled carbon fiber is highly graphitized and the fiber edge parts of the graphitized milled carbon fiber is subjected to a modifying treatment in the above procedure. The graphite material is suitable for a negative electrode of a lithium secondary battery capable of facilitating entering and leaving (doping and undoping) of lithium ions, having large discharge capacity and high charge/discharge efficiency and excellent charge/discharge cyclability. The present invention also provides a process for producing such graphite materials.

### FIELD OF THE INVENTION

The present invention relates to a process for producing a graphite material for a negative electrode of a lithium ion secondary battery, in which milled carbon fiber, particularly milled mesophase pitch-based carbon fiber, is mixed with a boron compound (including boron in this invention), and graphitized in a nitrogen-containing atmosphere and the graphitized milled carbon fiber is modified by impact applied selectively to its fiber edge parts, and to the graphite material obtained by the above process.

### BACKGROUND OF THE INVENTION

The secondary battery in which an alkali metal such as lithium is used as an active material of a negative electrode has generally various advantages. For example, it not only ensures high energy density and high electromotive force, but also has wide operating temperature range due to the use of a nonaqueous electrolytic solution. Further, the secondary battery is excellent in shelf life, miniaturized and lightweight.

Therefore, the practical use of the above nonaqueous-electrolytic solution lithium secondary battery is anticipated as a power source for use in a portable electronic appliance and also as a high-performance battery for use in an electric vehicle and electricity storage.

However, all the developed prototype batteries have not fully realized the above properties anticipated from the lithium secondary battery, and thus have been incomplete from the viewpoint of charge/discharge capacities, cycle life, and energy density.

A major cause thereof resided in a negative electrode used in the secondary battery.

For example, a lithium secondary battery having a negative electrode composed of metal lithium incorporated therein had disadvantageously short cycle life and poor safety because lithium deposited on the surface of the negative electrode during charging formed acicular dendrite causing short-circuit to be likely to occur between the positive and negative electrodes.

Lithium has extremely high reactivity, thereby causing the electrolytic solution to suffer from decomposition reaction in the vicinity of the surface of the negative electrodes. Thus, there was the problem that the above decomposition reaction would deform the surface of the negative electrode to thereby cause repeated uses of the secondary battery to lower the cell capacity.

Various studies have been made on the material of the negative electrode with a view toward obviating the above problems of the lithium second battery.

For example, the use of alloys containing lithium, such as lithium/aluminum alloy and Wood's alloy, as the material of the negative electrode of the lithium secondary battery has been studied. However, this negative electrode composed of such a lithium alloy had a problem of crystal structure change attributed to the difference in operating temperature and charge and discharge conditions.

Further, the use of carbon materials or graphite materials as the material of the negative electrodes of the lithium secondary battery has been studied.

For example, an attempt has been made to capture lithium ions formed during charging between graphite layers of a carbon material or a graphite material (intercalation) to thereby produce a compound so-called “intercalation compound” for the purpose of preventing the formation of dendrite.

Coal, coke, and PAN and isotropic pitch-based carbon fibers have been studied as the carbon materials.

However, these carbon materials have several drawbacks, for example, in that not only are graphite crystallites small but also the crystals are disorderly arranged, so that the charge/discharge capacities thereof are unsatisfactory, and in that, when the current density is set high at the time of charging or discharging, decomposition of the electrolytic solution occurs to thereby lower the cycle life.

Graphite materials such as natural and artificial graphites are now attracting most intensive attention as the carbon material for forming the negative electrode for use in the lithium ion secondary battery and are being extensively studied.

Although, the chargeable or dischargeable capacity per weight of the natural graphite is pretty large if the graphitization degree thereof is high, the natural graphite has drawbacks in that the current density ensuring ready discharge is low and in that the charging and discharging at a high current density would lower the charge and discharge efficiency. This natural graphite material is not suitable for use in a negative electrode of a high-load power source from which a large amount of current must be discharged and into which it is desired to effect charging at a high current density in order to save charging time, e.g., a power source for a device equipped with a drive motor or the like.

In the negative electrode composed of conventional artificial graphite, large charge/discharge capacities are obtained, as long as the graphitization degree thereof is high. However, the artificial graphite has also not been suitable for charging and discharging at a high current density.

In the contemporary lithium ion secondary battery in which use is made of the negative electrode comprising the graphite material, the current density at the time of charging is generally 50 mA/g or less, and thus charging time takes about 10 hours or more in view of the cell capacity. If the charging can be performed at a higher current density, for example, 100 mA/g, the charging time can be as short as 5 hours or less. Further, if the current density is 500 mA/g, the charging time can be even as short as 1 hour or less.

It has been reported that, among the above graphite materials, which include natural and artificial graphites, graphite fibers obtained by graphitizing carbon fibers of which a starting material is mesophase pitch is superior in various battery properties, as disclosed in Japanese Patent Application Laid-Open Publication No. 6(1994)-168725.

However, the carbon materials are various in the size and configuration of crystallites, the content of impurities, etc., depending on the type of the starting material and the manufacturing conditions. Thus, the problem is encountered that, with respect to the above graphite fiber as well, it can hardly be stated that the internal texture structure of the fiber is controlled so as to take a form optimum as the carbon material for lithium-ion secondary battery. Consequently, the current situation is that a carbon material, which is satisfactory in all respects including cycle life and charge/discharge capacities, has not yet been developed.

Japanese Patent Application Laid-Open Publication No. 6(1994)-333601 and Japanese Patent Application Laid-Open Publication No. 7(1995)-73898 disclose a lithium secondary battery in which the carbon material having part of the graphite-layer forming carbon atoms thereof replaced by boron atoms is used as the carbon material of the lithium secondary battery to thereby improve lithium-associated charge/discharge capacities. However, the above carbon material without exception is synthesized by the CVD process in which use is made of boron chloride (BCl₃) and benzene (C₆H₆) and has had a drawback in that the replacement of graphite-crystal-lattice forming carbon atoms per se by other atoms according to the CVD process, not only is a special complicated device needed but also a considerably high technique is necessary for controlling the degree of the replacement.

Further, Japanese Patent Application Laid-Open Publication No. 3(1991)-245458 proposed the use, as a negative electrode of lithium secondary battery, of the carbon material or carbon fiber both containing 0.1 to 2.0% by weight of boron, which is obtained by sintering a copolymer of furfuryl alcohol and maleic anhydride or a polyamide fiber at a low temperature of about 1,200° C. However, the carbon material or carbon fiber obtained by the proposed sintering method is not satisfactory in respect of the increase of charge/discharge capacities, even if the residual boron content is increased. Especially, the use of this carbon material has not attained any improvement in cell voltage.

Still further, Japanese Patent Application Laid-Open Publication No. 5(1993)-251080 proposed the carbon material obtained by adding, for example, H₃BO₃ to natural graphite and sintering the resultant natural graphite at 1,000° C. The disclosure of this literature includes the suggestion of adding boron in an amount of up to 10% by weight prior to the sintering of natural graphite for facilitating incorporation of lithium ions in the carbon material to thereby improve the battery performance exhibited when the carbon material is used in the negative electrode of the battery. However, this literature is silent on the elucidation of the mechanism of the negative electrode.

As the sintering (graphitization) method enabling commercial mass production of graphite materials, so-called Acheson type furnace can be used, wherein products to be sintered are set in the furnace to be covered with coke in the circumference, and direct current is applied from electrodes provided at the both ends of the furnace to heat the products. Inside of the Acheson type furnace is usually in an atmospheric condition. This brings about a problem that sufficient electrode characteristics can not be obtained for the graphite material to be used as a negative electrode of a lithium secondary battery, because the reaction of the boron compound with nitrogen, taking place in the production of graphite materials by sintering in the presence of a boron compound, inevitably generates insulating boron nitride on the graphite material surface.

The present inventors made an earnest study to solve the problems related to the prior art and found that it is effective to modify graphitized milled carbon fiber obtained by graphitizing a mixture of milled carbon fiber, particularly milledmesophase pitch-based carbon fiber, andaboron compound in a nitrogen-containing atmosphere, by impact applied selectively to its fiber edge parts. Thus, the present invention has been accomplished.

### OBJECT OF THE INVENTION

The present invention has been made for the purpose of solving the above problems related to the conventional graphite materials, and the object of the present invention is to provide a graphite material for a negative electrode of a lithium ion secondary battery, which is large in charge/discharge capacity, high in charge/discharge efficiency, and low in deterioration of battery cycle characteristics, by performing specific modifying treatment to fiber edge parts of graphitized milled carbon fiber, and a process for producing the same.

### SUMMARY OF THE INVENTION

The process for producing a graphite material for a negative electrode of a lithium ion secondary battery according to the present invention comprises the steps of:

mixing milled carbon fiber with a boron compound,

graphitizing the mixture in a nitrogen-containing atmosphere, and

performing modifying treatment by applying impact selectively to fiber edge parts of the graphitized milled carbon fiber.

The modifying treatment is preferably carried out by spinning graphitized milled carbon fiber in a high-speed gas stream to float and bringing its fiber edge parts into a collision with a high-speed rotating impact plate.

Also preferably, the average particle size of the graphitized milled carbon fiber, as measured by a laser diffractometry, decreases by 3 μm or less after the modifying treatment. Further, the value of [(B+N)/(B+C+N+O)] (%) calculated from the carbon atomic concentration (C), the boron atomic concentration (B), the nitrogen atomic concentration (N) and the oxygen atomic concentration (O) on the graphitized milled carbon fiber surface, as measured by X-ray photoelectron spectroscopy, decreases by 5% or less after the modifying treatment.

The ratio A of the heat of adsorption of 1-butanol on the graphitized milled carbon fiber, as determined by a liquid phase adsorption process, before and after the modifying treatment, represented by the following formula [I], is preferably 1.5 or less.

The ratio B of the specific surface area, as measured by a BET adsorption process, before and after the modifying treatment, represented by the following formula [II], and the ratio A of the heat of adsorption preferably satisfy a relation of A<B.

Ratio A=The heat of adsorption after the modifying treatment (J/g)/The heat of adsorption before the modifying treatment (J/g) [I]

Ratio B=Specific surface area after the modifying treatment (m²/g)/Specific surface area before the modifying treatment (m²/g) [II]

The graphite material for a negative electrode of a lithium ion secondary battery according to the present invention is produced by the above process of the present invention.

Desirably, the graphite material for a negative electrode of a lithium ion secondary battery of the present invention is the above milled carbon fiber comprising a mesophase pitch as the raw material.

### BRIEF DESCRIPTION OF THE DRAWINGS

FIG. 1 is a schematic view of fiber edge parts of the graphitized milled carbon fiber of the present invention.

FIG. 2 is a picture taken by a scanning electron microscope showing a fiber edge part of the graphitized milled carbon fiber before the modifying treatment.

FIG. 3 is a picture taken by a scanning electron microscope showing a fiber edge part of the graphitized milled carbon fiber after the modifying treatment.

### DETAILED DESCRIPTION OF THE INVENTION

The graphite material for a negative electrode of a lithium ion secondary battery of the present invention and the process for producing the same will be described in detail hereinafter.

### Milled Carbon Fiber

The milled carbon fiber for use in the present invention can be prepared by milling usual carbon fiber, preferably mesophase pitch-based one. The use of the milled mesophase pitch-based carbon fiber as the carbon material can give a lithium ion secondary battery large in charge/discharge capacity, high in energy density, excellent in charge/discharge cyclability and in charge/discharge rate, compared with the usual milled carbon fiber.

Milled mesophase pitch-based carbon fiber preferable for use in the present invention is disclosed in Japanese Patent Application Laid-Open Publication No.8(1996)-315820 by noting that the fiber has an oriented structure of an internal bent graphite-layered plane structure, in which the graphite layers extend in a circumferential direction piling one upon the other in a tegular state to show tegular gaps on the fiber surface, through which lithium ions enter and leave.

The milled carbon fiber, in this invention, generally means a cluster of fibers milled to 1 mm or less in length. That is, the milled carbon fiber is distinguished from carbon fibers of 1 to 25 mm in length, i.e., chopped strand carbon fibers. Preferably, the milled carbon fiber of the present invention has an average particle size, as measured by a laser diffractometry, of 10 to 50 μm. The milled carbon fiber of the above average particle size can give a graphite material for a negative electrode of a lithium ion secondary battery high in initial charge/discharge efficiency, low in deterioration of cyclability, and high in bulk density of electrode and in energy density per volume. The above carbon fiber is preferable also from the standpoint of short-circuit.

The average particle size is determined from the particle size distribution measured by a laser diffractometry. The aspect ratio (the ratio of the length to the diameter) of the milled carbon fiber of the present invention is from 2 to 30, preferably 2 to 15. The milled carbon fiber with the aspect ratio of the above range can give a graphite material for a negative electrode of a lithium ion secondary battery high in bulk density of electrode and in energy density per volume. When carbon fibers are milled to have the aspect ratio of the above range, most of the carbon fibers will be cut in the right angle to the fiber axis direction with the result that the ratio of a fiber edge part of the milled carbon fiber increases, which is preferable because of facilitated entering and leaving of lithium ions. The aspect ratio is determined based on the average value of 100 sample sizes in sampling inspection of the milled carbon fiber.

In order to produce the milled carbon fiber of the present invention, the carbon fiber can be milled directly after infusibilized. Preferably, it is milled after carbonized lightly in an inert gas at a temperature of 250 to 1,500° C. Carbonizing the carbon fiber lightly at a temperature of 250 to 1,500° C., preferably 500 to 900° C. followed by milling, has an effect that longitudinal cracks occurred in the fiber is relatively avoided, and graphite layer surfaces newly exposed in milling have tendencies of advancing polycondensation and cyclization reaction at the time of graphitization at a higher temperature, with the result that the activity of the surface lowers, inhibiting the electrolytic solution decomposition, in comparison with the carbonization at a temperature outside of the above range.

Heat treatment (carbonization or graphitization) at a temperature of over 1,500° C. followed by milling is not preferable because it brings about frequent cleavage occurrences along the graphite layer plane extending in the fiber axis direction, with the result that the ratio of the rupture surface area to the whole surface area of the milled carbon fiber increases, possibly causing the electrolytic solution decomposition by localization of electrons in the rupture graphite layer plane. It is considered that heat treatment at a temperature below 250° C. hardly induces carbonization, and the heat treatment has little effective. For milling of the carbon fiber after the infusibilization or the light carbonization, it is valuable to use of the Victory mill, a jet mill or a cross-flow mill, which is particularly not limited.

Milling the carbon fiber can be carried out by a method of using the Henschel mixer, a ball mill or an attritor. The method thereof, however, is not preferable because the carbon fiber could be cracked longitudinally in the fiber axis direction owing to the function of the pressure applied perpendicularly to the fiber. The method requires a long time for milling, and this is not a perfectly proper milling method for the present invention.

In most cases, the penetration of lithium ions from the carbon fiber side wall is relatively difficult. Therefore, they enter and leave the milled carbon fiber mainly through the fiber edge parts thereof. Accordingly, the battery capacity remarkably lowers when the charging/discharging rate is increased. As such, the milled carbon fiber is desired to be short, in other wards, to have the largest proportion of its fiber edge parts to the whole for smooth entering and leaving of lithium ions. However, when the fiber is excessively milled to be fine powder, active graphite layers are newly exposed to react with the electrolytic solution, inviting return disadvantages, e.g., deterioration in efficiency and capacity. Consequently, the production conditions are to be adjusted to attain the aspect ratio of themilled fiber after the graphitization of2 to 30, preferably 2 to 15, to obtain a negative electrode of a secondary battery having a high bulk density.

The carbon fiber for the milled carbon fiber of the invention is produced as follows.

The raw material of the carbon fiber is a readily graphitizable hydrocarbon which can be arbitrarily selected without limitation. Exemplary hydrocarbons are condensed polycyclic hydrocarbon compounds, e.g., naphthalene and phenanthrene; and condensed heterocyclic compounds, e.g., petroleum and a coal-based pitch. The raw material of the carbon fiber is preferably petroleum or a coal-based pitch. Particularly preferably, it is an optically anisotropic pitch, i.e., a mesophase pitch. The mesophase pitch has a mesophase content of 100%, which is not limited thereto as long as the spinning is practicable.

The method for fusing and spinning the starting pitch is not limited. For example, use can be made of melt spinning, melt blowing, centrifugal spinning and vortex spinning methods. In view of the spinning productivity and the fiber quality, the melt blowing method is preferable. The diameter of a spinning hole for melt blowing spinning is in the range of 0.1 to 0.5 mm, preferably 0.15 to 0.3 mm. That is, the diameter of a spinning hole in the above range gives advantages of hardly inducing clogging of a spinning hole and easy production of a spinning nozzle.

The spinning is preferably performed through the spinning holes of the above range in view of quality control, because the fiber obtained has a diameter of 4 to 25 μm so that has a narrow diameter dispersion. The carbon fiber having the diameter of the above range is preferable because it can give the milled carbon fiber having the above average particle size and the aspect ratio, even if the volume of the carbon fiber is decreased after the milling and the graphitization.

The spinning speed is 500 m/min or more, preferably 1500 m/min or more, even more preferably 2000 m/min or more in view of productivity.

The spinning temperature, which varies in some degree depending on the starting pitch, is higher than the softening point of the starting pitch and lower than the temperature at which the starting pitch is not changed in quality, generally from 300 to 400° C., preferably 300 to 380° C.

The melt blowing method of conducting spinning at a low viscosity of not more than several tens of poises and rapidly cooling, gives an advantage that the graphite layer planes are easily arranged in parallel with the fiber axis.

The starting pitch is advantageous, in connection with the above spinning temperature, to have a low softening point and to be high in reaction speed in the infusibilization in view of production cost and stability. Accordingly, the starting pitch is desired to have a softening point of 230 to 350° C., preferably 250 to 310° C.

The spun pitch fiber is subjected to infusibilization by a conventional method. The infusibilization can be carried out without specific limitations. For example, it is carried out by a method in which the pitch fiber is heated in an atmosphere of an oxidizing gas, e.g., nitrogen dioxide or oxygen; a method in which the pitch fiber is treated in an oxidizing aqueous solution, e.g., nitric acid or chromic acid; or a method in which the pitch fiber can be polymerized with light or γ rays. For further simplification, there is a method of treating with heat in air. The pitch fiber is treated with heat at an average heating rate of 3° C./min or more, preferably 5° C./min or more to reach about 350° C., although the average heating rate varies slightly depending on the kind of pitch fiber.

### Graphitization

The graphitization of the milled carbon fiber of the present invention is a treatment to form an advanced graphite structure (such having a graphite layer-to-layer spacing (d002) of 0.338 nm or less, as measured by X-raydiffractometry) by treating the milled carbon fiber in the presence of a boron compound.

In the present invention, the milled carbon fiber is mixed with a boron compound and graphitized in a nitrogen-containing atmosphere.

Particularly non-limiting examples of the method of addition of the boron compound may include a method of generally adding a solid boron compound directly and mixing uniformly according to necessity, and a method of preparing a solvent solution of a boron compound and immersing the fiber therein. The boron compound can be added before spinning, i.e., to a starting pitch. The boron compound is added in an amount of 15% by weight or less, preferably 0.5 to 5% by weight in terms of boron based on the material to be graphitized. The graphitization using the boron compound in the above amount is high in graphitization effect and preferable costwise. On the other hand, the graphitization using the boron compound in an amount exceeding 15% by weight is not preferable because the problems may occur, e.g., that the residual amount of boron in the graphitized milled carbon fiber is so large that carbon materials adhere to each other.

Non-limiting examples of the boron compounds include boron, boron carbide (B₄C), boron chloride, boric acid, boron oxide, sodium borate, potassium borate, copper borate and nickel borate.

Particularly non-limiting examples of the solvents to prepare the solvent solution include water, methanol, glycerin and acetone, which are appropriately selected according to the employed boron compound. When the boron compound is added in a solid state, the compound having an average particle size of 500 μm or less, preferably 200 μm or less is favorable to achieve uniform mixing with the milled carbon fiber.

In the present invention, it is important to highly graphitize the milled carbon fiber. Thus, the milled carbon fiber is necessary to be mixed with a boron compound and graphitized at a temperature of 2,200° C. or higher, preferably 2,400° C. or higher.

The graphitization of the milled carbon fiber can be noticeably accelerated when carried out around a temperature higher than the melting point of the boron compound (boron: 2,080° C., boron carbide: 2,450° C.), although the mechanism of the effect of the boron compound is not well understood. The graphitized milled carbon fiber thus obtained has an effect of increasing the charge/discharge capacities when used as a negative electrode of a battery.

The graphitization of the present invention can be carried out by an appropriate sintering (graphitization) method enabling commercial mass production of graphite materials, for example, using the so-called Acheson type furnace.

The average particle size of the graphitized milled carbon fiber obtained by the graphitization of the present invention, as measured by a laser diffractometry, is preferably 8 to 45 μm.

### Modifying Treatment

The modifying treatment of the graphitized milled carbon fiber of the present invention is performed by applying impact selectively to the fiber edge parts of the graphitized milled carbon fiber. The treatment enables more efficient entering and leaving of the lithium ions traveling in the fiber axis direction, with the result that the carbon fiber exhibits excellent characteristics as a negative electrode.

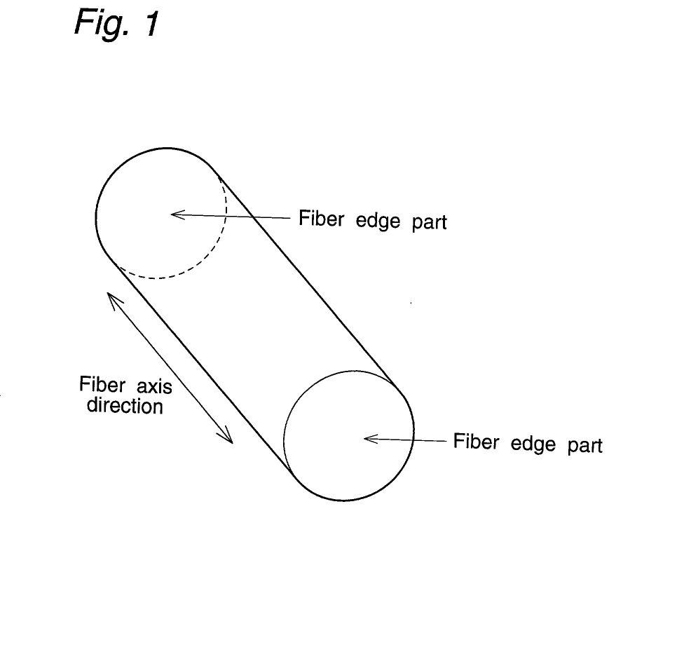

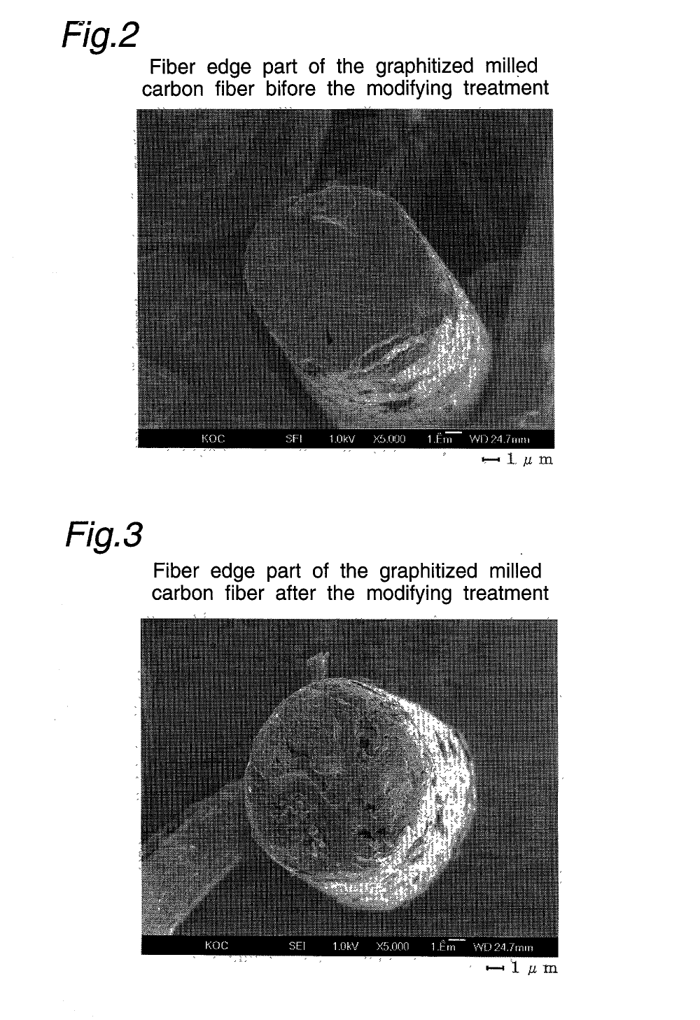

The fiber edge part of the graphitized milled carbon fiber referred to this specification is a cross section exposed as a result of cutting the fiber at a right angle to the fiber axis, as is indicated in FIG. 1.

The method for the modifying treatment is not particularly limited as long as it can selectively apply impact to the fiber edge parts. For example, commonly used is a method of bringing the graphitized milled carbon fiber into a collision with an impact plate in a stream (jet milling method) The modifying treatment using, e.g., a jet mill, enables selective impact application to the fiber edge parts of the graphitized milled carbon fiber by bringing it into a collision with an impact plate, because the graphitized milled carbon fiber flows in a stream in the state that the fiber axis direction is orientated in line with the stream direction owing to the fiber shape unbent in view of the aspect ratio.

Fine powder generation as the result of the modifying treatment for the graphitized milled carbon fiber of the present invention is less in comparison with that of the graphite particle materials obtained from pitch coke as the raw material, partially because of the high hardness of the carbon fiber.

The treatment conditions for the modifying treatment can be appropriately selected. First, the modifying treatment is performed under the conditions that:

the average particle size of the graphitized milled carbon fiber decreases by 3 μm or less, preferably 2 μm or less after the modifying treatment; further,

the value of [(B+N)/(B+C+N+O)] (%) calculated from the carbon atomic concentration (C), the boron atomic concentration (B), the nitrogen atomic concentration (N) and the oxygen atomic concentration (O) on the graphitized milled carbon fiber surface, as measured by X-ray photoelectron spectroscopy, decreases by 5% or less, preferably 3% or less after the modifying treatment.

In the case where the average particle size decreases by exceeding 3 μm and the value of [(B+N)/(B+C+N+O)] (%) decreases by exceeding 5% after the modifying treatment, graphitized milled carbon fiber is thought to have suffered from excessive impact, with the result that active surfaces high in reactivity with the electrolytic solution are newly formed. Such graphitized milled carbon fiber can increase its reactivity with the electrolytic solution when used in a lithium ion secondary battery. The modifying treatment of the above is not preferable because it will also generate a large amount of fine powder.

Second, the modifying treatment is desirably performed under the conditions that:

the ratio A of the heat of adsorption of 1-butanol on the graphitized milled carbon fiber before and after the modifying treatment, as measured by a liquid phase adsorption method, is 1.5 or less, preferably 1.3 or less:

Ratio A=The heat of adsorption after the modifying treatment (J/g)/ The heat of adsorption before the modifying treatment (J/g); and

the ratio B of the specific surface area before and after the modifying treatment, as measured by a BET adsorption method, and the ratio A of the heat of adsorption satisfy a relation of A<B:

Ratio B=Specific surface area after the modifying treatment (m²/g)/Specific surface area before the modifying treatment (m²/g)

In the case where the ratio A of the heat of adsorption is exceeding 1.5 and the relation between the ratio A and the ratio B is A≧B, increase of active surfaces of the graphitized milled carbon fiber, on which 1-butanol is thought to be adsorbed, is so large that the reaction with the electrolytic solution increases, inviting the deterioration in charge/discharge efficiency and in battery cyclability.

In this invention, entering and leaving (doping and undoping) of lithium ions can be facilitated by performing the modifying treatment to satisfy either the first treatment conditions or the second treatment conditions to allow production of graphite materials for a negative electrode of a lithium ion secondary battery high in discharge capacity and in charge/discharge efficiency and excellent in charge/discharge cyclability. Preferably, the modifying treatment is performed to satisfy the both treatment conditions to enable production of graphite materials for a negative electrode of a lithium ion secondary battery further improved in the above properties.

The measuring method of the heat of adsorption of 1-butanol on the graphitized milled carbon fiber as measured by a liquid phase adsorption method is described hereinafter.

In the present invention, the measurement is made by a liquid phase adsorption method using a microcalorimeter. First, a sample for measurement is charged in a cell of a given volume, and dried under reduced pressure at 25° C. for 15 hours. Next, heptane is introduced as the nonpolar carrier solvent to fill up the cell accommodating the sample, and is allowed to flow in the cell continuously. The introduced solvent is then altered from heptane to 1-butanol. 1-Butanol is introduced at a rate of 3 ml/min into the cell to substitute the solvent in the cell with heptane. At the same time, the heat of adsorption generated by the adsorption of 1-butanol on active surfaces of the sample is measured with a microcalorimeter. 1-Butanol is a polar solvent and selectively adsorbed on the polar active surfaces.

### Graphite Material for Negative Electrode of Lithium Ion Secondary Battery

The graphite material for a negative electrode of a lithium ion secondary battery (sometimes abbreviated to “graphite material” hereinafter) of the present invention has a structure in which the graphite layer-to-layer spacing (d002), as measured by X-ray diffractometry, is 0.338 nm or less, preferably 0.336 nm or less; the size of a crystallite of c-axis direction (Lc) is 35 nm or more, preferably 45 nm or more; the size of a crystallite of a-axis direction (La) is 50 nm or more, preferably 60 nm or more; and the intention ratio of the diffraction peak of a (101) plane to that of a (100) plane (I₁₀₁/I₁₀₀) is not less than 1.5. These are an indication of the graphitization degree of the graphite material respectively. The graphite material is requested to satisfy all the above conditions for improving the battery performance.

Various X-ray parameters used to determine the structure of the graphite material of the present invention are briefly described.

The X-ray diffractometry is a method in which the diffraction pattern of the carbon fiber and the like is measured using Cukα as a X-ray source and highly purified silicon as a standard substance. The graphite layer-to-layer spacing (d002) and the size of a crystallite of c-axis direction Lc(002) are each calculated from the peak position of the (002) plane diffraction pattern and the half band width thereof; and the size of a crystallite of a-axis direction La(110) is calculated from the peak position of the (110) plane diffraction pattern and the half band width thereof, both based on the method of the Japan Society for Promotion of Sciences. The intention ratio (I₁₀₁/I₁₀₀) is determined through a procedure comprising the steps of drawing a base line on the obtained diffraction pattern diagram, measuring the heights of the (101) plane diffraction peak (2θ≈44.5) and the (100) plane diffraction peak (2θ≈42.5) from the base line, and dividing the height of the (101) plane diffraction peak by the height of the (100) plane diffraction peak.

### Lithium Ion Secondary Battery

The lithium ion secondary battery using the graphite material of the present invention as a negative electrode, can be produced by, for example, the following method.

The graphite material of the present invention is incorporated with a binder, e.g., polyethylene, polytetrafluoroethylene (PTFE), polyvinylidene fluoride (PVDF) and styrene-butadiene rubber (SBR), and formed into a shape suitable for the negative electrode, e.g., sheet or tabular form, by the use of a press roll to give a negative electrode used in a lithium ion secondary battery. The negative electrode thus produced using the graphite material is of high performance, enabling high capacity per unit volume and miniaturization of a battery.

The electrolytic solution used in the production of a lithium ion secondary battery using the graphite material of the present invention as a negative electrode, is one capable of dissolving a lithium salt therein, preferably a non-protonic organic solvent having high dielectric constant. Particularly non-limiting examples of the organic solvents include propylene carbonate, ethylene carbonate, tetrahydrofuran, 2-methyl tetrahydrofuran, dioxolane, 4-methyl-dioxolane, acetonitrile, dimethyl carbonate, methylethyl carbonate and diethyl carbonate. These solvents are employed either individually or in proper combination.

The electrolyte is not limited as long as it is a lithium salt forming stable anions. Preferable examples thereof are lithium perchlorate, lithium borofluoride, lithium hexachloroantimonate and lithium hexafluorophosphate (LiPF₆)

The positive electrode of a lithium ion secondary battery is not limited. For example, usable are metallic oxides, e.g., chromium oxide, titanium oxide, cobalt oxide and vanadium pentoxide; lithium metal oxides, e.g., lithium manganese oxide (LiMn₂O₄), lithium cobalt oxide (LiCoO₂) and lithium nickel oxide (LiNiO₂); transition metal chalcogen compounds, e.g., titanium sulfide and molybdenum sulfide; and conductive conjugated polymeric substances, e.g., polyacethylene, polyparaphenylene and polypyrrole.

A separator, e.g., nonwoven or woven fabrics of synthetic fiber or glass fiber, a polyolefin porous membrane or a nonwoven fabric of polytetrafluoroethylene, is provided between the positive and negative electrodes. A current collector can be used as in conventional batteries. The current collector for a negative electrode, a conductor electrochemically inert to the electrode and the electrolytic solution, e.g., metals such as copper, nickel, titanium and stainless steel, can be used in the form of a plate, a foil or a bar. The secondary battery produced according to the present invention, using the negative electrode specified herein and constitutional components including the separator, the current collector, a gasket, a sealing plate and a casing, can be produced into a cylindrical, rectangular or buttony type battery in the usual way.

### EFFECT OF THE INVENTION

The present invention provides a graphite material suitable for a negative electrode of a lithium secondary battery capable of facilitating entering and leaving (doping and undoping) of lithium ions through the graphitized milled carbon fiber, and having large discharge capacity, high charge/discharge efficiency and excellent charge/discharge cyclability, which material is produced through the procedure comprising the steps of mixing milled carbon fiber with a boron compound, subjecting to graphitization in the presence of nitrogen to graphitize the mixture highly, and applying impact selectively to graphitized milled carbon fiber edge parts to render modifying treatment. The present invention also provides a process for producing such graphite material.

### EXAMPLE

The present invention will be described in detail with reference to the examples, which are not to limit the scopes of the invention in any way.

### Example 1

(Production of Graphite Material)

An optically anisotropic petroleum mesophase pitch having a specific gravity of 1.25 was used as a starting material. Using a spinning nozzle having 500 spinning holes with a 0.2 mm diameter provided in a line in a 3 mm wide slit, the molten pitch was blown by injecting hot air from the slit, thereby pitch fiber having an average diameter of 15 μm was obtained. During the process, the spinning temperature was 360° C. and the output rate was 0.8 g/hole·min. The spun fiber was collected on a belt having a collection zone of 20-mesh stainless steel net with suction from the backside of the belt.

The collected fiber mat was heated in air from room temperature to 300° C. at an average heating rate of 6° C./min to carry out infusibilization. Subsequently, the infusibilized fiber was lightly carbonized at 650° C., and then pulverized by a cross-flow mill, to obtain milled carbon fiber having an average particle size of 24.5 μm. To the milled carbon fiber, 3% by weight of boron carbide having an average particle size of 10 μm was added, uniformly mixed with stirring, and thereafter graphitized by heating to 3,000° C. over 8 hours in an Acheson type furnace (in atmosphere) and keeping at the temperature for 10 hours, to prepare graphitized milled carbon fiber.

According to measurement by X-ray diffractometry, the resulting graphitized milled carbon fiber had a graphite layer-to-layer spacing (d002) of 0.3355 nm, a size of a crystallite of c-axis direction (Lc) of not less than 100 nm, a size of a crystallite of a-axis direction (La) of not less than 100 nm, and an intension ratio of the diffraction peak of a (101) plane to that of a (100) plane (I₁₀₁/I₁₀₀) of 2.10.

The average particle size of the fiber after the graphitization was 17.5 μm.

The boron nitride amount generated on the graphitized milled carbon fiber surface was determined from the values of C1s, O1s, B1s and N1s measured by the X-ray photoelectron spectroscopy (XPS) . The value of (B+N) / (B+N+C+O), as calculated from the boron atomic concentration (B), the nitrogen atomic concentration (N), the carbon atomic concentration (C) and the oxygen atomic concentration (O), was 22.5%(atomic concentration).

The heat of adsorption of 1-butanol for the graphitized milled carbon fiber, as measured by the above method (liquid phase adsorption method) using a twin type calorimeter, was 78 J/g. The specific surface area of the graphitized milled carbon fiber, as measured by a BET adsorption method with nitrogen, was 0.7 m²/g.

Next, the modifying treatment of the graphitized milled carbon fiber was carried out using UltraPlex under treating conditions of a rotor rotation of 3,000 rpm and a throughput rate of 100 kg/H.

The average particle size of the fiber after the modification treatment was 16.7 μm. As a result of measuring the boron nitride amount generated on the fiber surface by the X-ray photoelectron spectroscopy, the value of (B+N)/(B+N+C+O) was 22.0%(atomic concentration). The fiber had a heat of adsorption of 1-butanol of 100 J/g and a specific surface area of 1.4 m²/g, as measured with the above procedures.

The results of the surface-modifying treatment are given in Table 1.

(Charge/Discharge Test)

A negative electrode was made using the modified, graphitized milled carbon fiber. To 93 parts by weight of the modified, graphitized milled carbon fiber, a N-methyl-2-pyrrolydinone solution of polyvinylidene fluoride was added in such an amount that the polyvinylidene fluoride amount became 7 parts by weight, to prepare a slurry. The slurry was applied on copper foil having a thickness of 18 μm to make a negative electrode. The charge/discharge test was carried out by a triode cell using this negative electrode.

In detail, the charge/discharge capacity was measured using metal lithium for counter and reference electrodes, in an electrolyte solution prepared by dissolving 1 mol/l of lithium perchlorate (LiClO₄) as an electrolyte in a mixed carbonate solvent of ethylene carbonate (EC) and diethyl carbonate (DEC) in a volume ratio (EC/DEC) of 1/1. In the charging and discharging, the cell was charged at a constant electric current-constant voltage of 100 mA/g-10 mV for 8 hours and discharged at a constant electric current of 100 mA/g until the electric potential of 1.5 V/Li/Li⁺. The charging and discharging test was repeated 10 times.

The first cycle showed a discharge capacity of 350 mA h/g and a charge/discharge efficiency of 93.5%. The 10th cycle showed a high discharge capacity of 350 mA h/g and a high charge/discharge efficiency of 100.0%. The cycle was repeated stably 10 times.

The results of the charge/discharge test are given in Table 1.

### EXAMPLE 2

The modifying treatment of the graphitized milled carbon fiber prepared in Example 1 was carried out using UltraPlex under treating conditions of a rotor rotation of 3,800 rpm and a throughput rate of 100 kg/H.

The average particle size of the fiber after the modification treatment was 15.0 μm. As a result of measuring the boron nitride amount generated on the fiber surface by the X-ray photoelectron spectroscopy, the value of (B+N)/(B+N+C+O) was 19.3%(atomic concentration). The fiber had a heat of adsorption of 1-butanol of 111 J/g and a specific surface area of 2.4 m²/g, as measured with the above procedures.

The results of the surface-modifying treatment are given in Table 1.

(Charge/Discharge Test)

The procedure of the charge/discharge test of Example 1 was repeated. The first cycle showed a discharge capacity of 348 mA h/g and a charge/discharge efficiency of 92.8%. The 10^{th} cycle showed a high discharge capacity of 348 mA h/g and a high charge/discharge efficiency of 100.0%. The cycle was repeated stably 10 times.

The results of the charge/discharge test are given in Table 1.

### EXAMPLE 3

(Production of Graphite Material)

To the milled carbon fiber prepared in Example 1, 3% by weight of boron carbide having an average particle size of 80 μm was added, uniformly mixed with stirring, and thereafter graphitized in an Acheson type furnace (in atmosphere) in the same conditions as in Example 1, to thereby prepare graphitized milled carbon fiber.

According to measurement by X-ray diffractometry, the resulting graphitized milled carbon fiber had a graphite layer-to-layer spacing (d002) of 0.3358 nm, a size of a crystallite of c-axis direction (Lc) of not less than 100 nm, a size of a crystallite of a-axis direction (La) of not less than 100 nm, and an intension ratio of the diffraction peak of a (101) plane to that of a (100) plane (I₁₀₁/I₁₀₀) of 1.90.

The average particle size of the fiber after the graphitization was 18.5 μm.

The boron nitride amount generated on the graphitized milled carbon fiber surface was determined from the values of C1s, O1s, B1s and N1s in the same manner as in Example 1. The value of (B+N)/(B+N+C+O) was 13.2% (atomic concentration).

The heat of adsorption of 1-butanol for the graphitized milled carbon fiber, as measured by the above liquid phase adsorption method, was 63 J/g. The specific surface area of the graphitized milled carbon fiber, as measured by the BET adsorption method with nitrogen, was 0.6 m²/g.

Next, the modifying treatment of the graphitized milled carbon fiber was carried out using UltraPlex under treating conditions of a rotor rotation of 2,800 rpm and a throughput rate of 80 kg/H.

The average particle size of the fiber after the modification treatment was 17.0 μm. As a result of measuring the boron nitride amount generated on the fiber surface by the X-ray photoelectron spectroscopy, the value of (B+N)/(B+N+C+O) was 12.0% (atomic concentration). The fiber had a heat of adsorption of 1-butanol of 69 J/g and a specific surface area of 1.3 m²/g, as measured with the above procedures.

The results of the surface-modifying treatment are given in Table 1.

(Charge/Discharge Test)

The charge/discharge test was carried out in the same manner as in Example 1.

The first cycle showed a discharge capacity of 342 mA h/g and a charge/discharge efficiency of 94.2%. The 10th cycle showed a high discharge capacity of 342 mA h/g and a high charge/discharge efficiency of 100.0%. The cycle was repeated stably 10 times.

The results of the charge/discharge test are given in Table 1.

### EXAMPLE 4

(Production of Graphite Material) To the milled carbon fiber prepared in Example 1, 5% by weight of boron carbide having an average particle size of 80 μm was added, uniformly mixed with stirring, and thereafter graphitized in the same manner as in Example 1, to prepare graphitized milled carbon fiber.

According to measurement by X-ray diffractometry, the resulting graphitized milled carbon fiber had a graphite layer-to-layer spacing (d002) of 0.3356 nm, a size of a crystallite of c-axis direction (Lc) of not less than 100 nm, a size of a crystallite of a-axis direction (La) of not less than 100 nm, and an intension ratio of the diffraction peak of a (101) plane to that of a (100) plane (I₁₀₁/I₁₀₀) of 1.98.

The average particle size of the fiber after the graphitization was 17.3 μm.

The boron nitride amount generated on the graphitized and milled carbon fiber surface was determined from the values of C1s, O1s, B1s and N1s in the same manner as in Example 1. The value of (B+N)/(B+N+C+O) was 18.5%(atomic concentration).

The heat of adsorption of 1-butanol for the graphitized and milled carbon fiber, as measured by the above liquid phase adsorption method, was 69 J/g. The specific surface area of the graphitized milled carbon fiber, as measured by the BET adsorption method with nitrogen, was 0.6 m²/g.

Next, the modifying treatment of the graphitized milled carbon fiber was carried out using UltraPlex under treating conditions of a rotor rotation of 2,800 rpm and a throughput rate of 80 kg/H.

The average particle size of the fiber after the modification treatment was 16.8 μm. As a result of measuring the boron nitride amount generated on the fiber surface by the X-ray photoelectron spectroscopy, the value of (B+N)/(B+N+C+O) was 18.1%(atomic concentration). The fiber had a heat of adsorption of 1-butanol of 83 J/g and a specific surface area of 1.6 m²/g, as measured with the above procedures.

The results of the surface-modifying treatment are given in Table 1.

(Charge/Discharge Test)

The charge/discharge test was carried out in the same manner as in Example 1.

The first cycle showed a discharge capacity of 347 mA h/g and a charge/discharge efficiency of 93.7%. The 10th cycle showed a high discharge capacity of 347 mA h/g and a high charge/discharge efficiency of 100.0%. The cycle was repeated stably 10 times.

The results of the charge/discharge test are given in Table 1.

### COMPARATIVE EXAMPLE 1

(Production of Graphite Material)

The procedure of Example 1 was repeated to prepare graphitized milled carbon fiber.

Next, the modifying treatment of the graphitized milled carbon fiber was carried out using UltraPlex under treating conditions of a rotor rotation of 6000 rpm and a throughput rate of 100 kg/H.

The average particle size of the fiber after the modification treatment was 13.0 μm. As a result of measuring the boron nitride amount generated on the fiber surface, the value of (B+N)/(B+N+C+O) was 18.0% (atomic concentration). The fiber had a heat of adsorption of 1-butanol of 133 J/g and a specific surface area of 6.7 m²/g, as measured with the above procedures.

The results of the surface-modifying treatment are given in Table 1.

(Charge/Discharge Test)

The charge/discharge test was carried out in the same manner as in Example 1.

The first cycle showed a discharge capacity of 346 mA h/g and a charge/discharge efficiency of 87.1%. The 10th cycle showed a discharge capacity of 345 mA h/g and a charge/discharge efficiency of 99.5%. Any of the discharge capacity, charge/discharge efficiency and cyclability of the resulting fiber were lower than those of the fiber of Example 1.

The results of the charge/discharge test are given in Table 1.

### COMPARATIVE EXAMPLE 2

(Production of Graphite Material)

The procedure of Example 1 was repeated to prepare graphitized milled carbon fiber.

Next, the modifying treatment of the graphitized milled carbon fiber was carried out using a ball mill under treating conditions of a rotation speed of 150 rpm and a 5 kg/batch for 1 hr.

The average particle size of the fiber after the modification treatment was 13.4 μm. As a result of measuring the boron nitride amount generated on the fiber surface by the X-ray photoelectron spectroscopy, the value of (B+N)/(B+N+C+O) was 17.0%(atomic concentration). The fiber had a heat of adsorption of 1-butanol of 180 J/g and a specific surface area of 1.5 m²/g, as measured with the above procedures.

The results of the surface-modifying treatment are given in Table 1.

(Charge/Discharge Test)

The charge/discharge test was carried out in the same manner as in Example 1.

The first cycle showed a discharge capacity of 343 mA h/g and a charge/discharge efficiency of 80.5%. The 10th cycle showed a discharge capacity of 340 mA h/g and a charge/discharge efficiency of 99.5%. Any of the discharge capacity, charge/discharge efficiency and cyclability of the resulting fiber were lower than those of the fiber of Example 1.

The results of the charge/discharge test are given in Table 1.

### COMPARATIVE EXAMPLE 3

The procedure of Example 1 was repeated to prepare graphitized milled carbon fiber.

The charge/discharge test of the fiber prepared without the modifying treatment was carried out in the same manner as in Example 1.

The first cycle showed a discharge capacity of 330 mA h/g and a charge/discharge efficiency of 88.5%. The 10th cycle showed a discharge capacity of 320 mA h/g and a charge/discharge efficiency of 99.5%. Any of the discharge capacity, charge/discharge efficiency and cyclability of the resulting fiber were lower than those of the fiber prepared after the modifying treatment.

The results of the charge/discharge test are given in Table 1.

### COMPARATIVE EXAMPLE 4

The procedure of Example 4 was repeated to prepare graphitized milled carbon fiber.

The charge/discharge test of the fiber prepared without the modifying treatment was carried out in the same manner as in-Example 1.

The first cycle showed a discharge capacity of 331 mA h/g and a charge/discharge efficiency of 89.5%. The 10th cycle showed a discharge capacity of 322 mA h/g and a charge/discharge efficiency of 99.7%. Any of the discharge capacity, charge/discharge efficiency and cyclability of the resulting fiber were lower than those of the fiber prepared with the modifying treatment.

The results of the charge/discharge test are given in Table 1.

TABLE 1

| | | | | | Cmp | Cmp | Cmp | Cmp |
|---|---|---|---|---|---|---|---|---|
| | Ex. 1 | Ex. 2 | Ex. 3 | Ex. 4 | Ex. 1 | Ex. 2 | Ex. 3 | Ex. 4 |
| 1. Change in Physical Properties of Graphitized | | | | | | | Un- | Un- |
| Milled Carbon Fiber after Surface-Modifying | | | | | | | treated | treated |
| Treatment | | | | | | | | |
| Decrease in Average Particle Size: μm | 0.8 | 2.5 | 1.5 | 0.5 | 4.5 | 4.1 | — | — |
| Decrease in Value of (B + N)/(B + C + N + O): % | 0.5 | 3.2 | 1.2 | 0.4 | 4.5 | 5.5 | — | — |
| Ratio A of Heat of Adsorption *1 | 1.3 | 1.4 | 1.1 | 1.2 | 1.7 | 2.3 | — | — |
| Ratio B of Specific Surface Area *2 | 2.0 | 3.4 | 2.2 | 2.7 | 9.6 | 2.1 | — | — |
| Relation between Ratio A and Ratio B *3 | ◯◯ | ◯◯ | ◯◯ | ◯◯ | ◯◯ | XX | — | — |
| 2. Charge/Discharge Test | | | | | | | | |
| 1) Discharge Capacity: mA h/g | | | | | | | | |
| First cycle | 350 | 348 | 342 | 347 | 346 | 343 | 330 | 331 |
| Tenth cycle | 350 | 348 | 342 | 347 | 345 | 340 | 320 | 322 |
| 2) Charge/Discharge Efficiency: % | | | | | | | | |
| First cycle | 93.5 | 92.8 | 94.2 | 93.7 | 87.1 | 80.5 | 88.5 | 89.5 |
| Tenth cycle | 100.0 | 100.0 | 100.0 | 100.0 | 99.5 | 99.5 | 99.5 | 99.7 |

*1: The ratio A = Heat of adsorption after the modifying treatment (J/g)/Heat of adsorption before the modifying treatment (J/g).
*2: The ratio B = Specific surface area after the modifying treatment (m²/g)/Specific surface area before the modifying treatment (m²/g).
*3: ◯◯: A < B, XX: A ≧ B

What is claimed is:

1. A process for producing a graphite material for a negative electrode of a lithium ion secondary battery comprising the steps of:
mixing milled carbon fiber with a boron compound,
graphitizing the mixture in a nitrogen-containing atmosphere, and
performing modifying treatment by applying impact selectively to fiber edge parts of the graphitized milled carbon fiber.

2. The process for producing a graphite material for a negative electrode of a lithium ion secondary battery according to claim 1, wherein:
the modifying treatment is carried out by spinning the graphitized milled carbon fiber in a high-speed gas stream to float and bringing fiber edge parts of the carbon fiber into a collision with a high-speed rotating impact plate.

3. The process for producing a graphite material for a negative electrode of a lithium ion secondary battery according to claim 1 or 2, wherein, after the modifying treatment,
an average particle size of the graphitized milled carbon fiber, as measured by a laser diffractometry, decreases by 3 μm- or less, and
a value of [(B+N)/(B+C+N+O)] ( % ) calculated from carbon atomic concentration (C), boron atomic concentration (B), nitrogen atomic concentration (N) and oxygen atomic concentration (O) on the graphitized milled carbon fiber surface, as measured by X-ray photoelectron spectroscopy, decreases by 5% or less.

4. The process for producing a graphite material for a negative electrode of a lithium ion secondary battery according to any one of claims 1 to 3, wherein
a ratio A of the heat of adsorption of 1-butanol on the graphitized milled carbon fiber after the modifying treatment, as determined by a liquid phase adsorption process, to that before the modifying treatment, represented by the following formula [I], is 1.5 or less, and
a ratio B of the specific surface area, represented by the following formula [II], as measured by a BET adsorption process, and the ratio A of the heat of adsorption satisfy a relation of A<B:
Ratio A=The heat of adsorption after the modifying treatment (J/g)/The heat of adsorption before the modifying treatment (J/g) [I]
Ratio B=Specific surface area after the modifying treatment (m²/g)/Specific surface area before the modifying treatment (m²/g) [II].

5. A graphite material for a negative electrode of a lithium ion secondary battery produced by a process according to any one of claims 1 to 4.

6. The graphite material for a negative electrode of a lithium ion secondary battery according to claim 5, wherein the milled carbon fiber is produced from a mesophase pitch as a raw material.
